(19) United States
(12) Patent Application Publication
(10) Pub. No.: US 2025/0355272 A1
(43) Pub. Date: Nov. 20, 2025

(54) Motoviz

(71) Applicant: Nikikaya Mudd, Fayetteville, GA (US)

(72) Inventor: Nikikaya Mudd, Fayetteville, GA (US)

(21) Appl. No.: 18/666,489

(22) Filed: May 16, 2024

(51) Int. Cl. G02C 3/02; A42B 3/04

(52) U.S. Cl. CPC G02C 3/02; A42B 3/042

(57) ABSTRACT

The system and method for accommodating eyewear within a protective headgear are disclosed. The system includes an eyewear frame, an adjustable extension device, an adherence device, a protective headgear visor, and a protective headgear. The method involves detachably connecting an eyewear frame with an adjustable extension device, adjusting the length of the adjustable extension device, attaching the adherence device to the inner surface of the protective headgear visor, and accommodating the invention within the protective headgear.

### DETAILED DESCRIPTION

The inventor has conceived, an embodiment for effectively storing and transporting personal material.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Reference throughout this document to “adherence device”, “suction cup” or similar terms refers to a device coupled to the present embodiment for releasing the apparatus from an adjacent surface. The adherence device may have additional features and functions known in art for serving the purpose of attaching or releasing the embodiment from the adjacent surface. Thus, the appearance of similar phrases throughout this specification may not be limited to just the term “adherence device” but when the description refers to a structure that attaches or releases the embodiment from the adjacent surface then it may be inferred that the description refers to an adherence device.

Materials described or referenced herein will sometimes be described in singular form for clarity. However, it should be appreciated that particular embodiments may include multiple instantiations of a material unless noted otherwise. Surfaces in some embodiments can be understood as representing segments or portions of those embodiments. Alternate implementations are included within the scope of embodiments of the present invention would be understood by those having ordinary skill in the art.

Headings of sections provided in this patent application and the title of this patent application are for convenience only and are not to be taken as limiting the disclosure in any way. A description of an embodiment with several components in connection with each other does not imply that all such components are required.

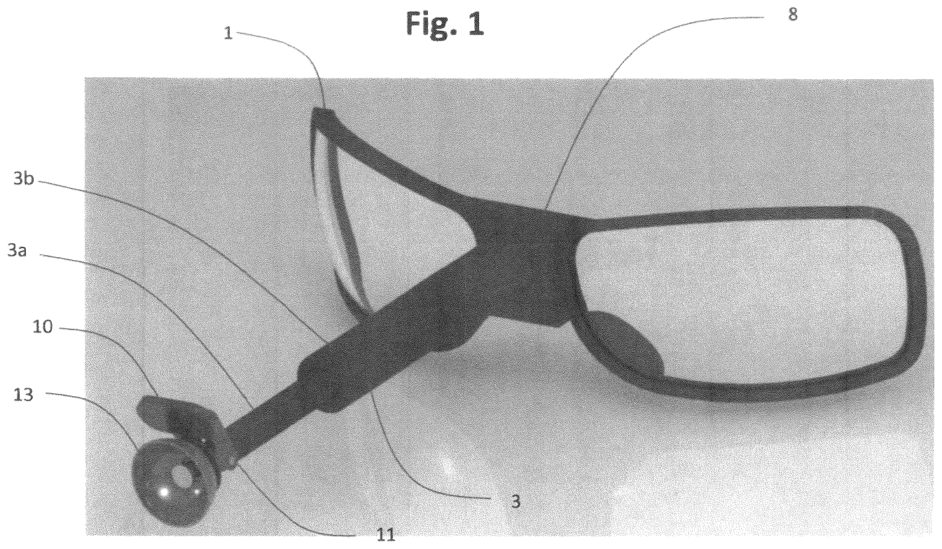

The claimed subject matter is now described with reference to the drawings, wherein like reference numerals are used to refer to like elements throughout. The embodiment includes an eye wear frame 1, a face shield portion 2, that are detachably joined by an adjustable extension device 3. With reference to the attached figures, as illustrated in FIG. 1 the embodiment is directed generally to an eye wear frame 1 that will be attached to the face shield portion 2 while in use. In a non-limiting example, a user can apply the embodiment while utilizing various types of recreational vehicles while using prescriptive eye wear. The embodiment is designed with two separate portions to include an adjustable extension device 3 that will be secured to the eye wear frame 1. The adjustable extension device 3 further includes an adherence device 4 that connects to a distal end that serves as a suction cup to allow a user to securely attach the adjustable extension device 3 to the interior surface of a full-face helmet visor 5. The adjustable extension device 3 is made of telescopic rods (3a, 3b). The telescopic rods includes a male end 3a that is used to be inserted into the female end 3b of the extension device. The adherence device 4 plays a key role in the eyewear accommodation system, enabling the secure placement of prescription lenses (7a, 7b) within a full-face helmet. This system includes the suction cup 13, and is part of the adherence device 4 subsystem. The adherence device 4 is primarily designed to affix the apparatus to the inner surface of a full-face helmet visor, ensuring the stability and adjustability of the eyewear frame within the helmet. The suction cup 13 operates by creating a vacuum seal against the visor surface, which is achieved by pressing the suction cup 13 against the visor and expelling air from the interface. This action generates a partial vacuum, increasing the frictional force and maintaining the position of the eyewear frame. The adherence device 4 is equipped with a releasing mechanism on its rear portion, allowing for detachment of the suction cup 13 from the visor when desired. This mechanism functions by reintroducing air into the vacuum space, facilitating the removal of the suction cup 13.

In a non-limiting example, the adherence device 4 includes a suction cup 13, pin 11, and a releasing mechanism 10 or other devices known in the art.

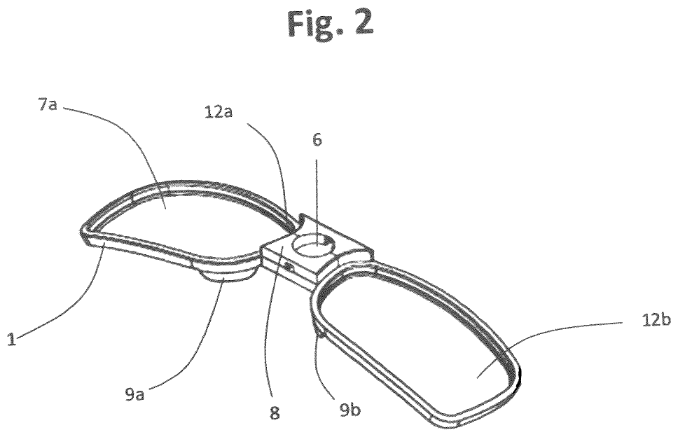

Turning now to FIG. 2 the apparatus is shown from a front-view in an ideal embodiment. FIG. 2 is described with reference to FIG. 1. The drawing is further shown with a centered aperture 6 for receiving the adjustable extension device 3. The apparatus as shown depicts eye wear frame 1 with lenses (7a, 7b) with the aperture 6 positioned between the lenses (7a, 7b). The aperture 6 is critical for engaging the adjustable extension device 3 while in use so that the user will have the advantage of wearing prescription lenses while also wearing a full-face helmet visor 5. The adjustable extension device 3 will extend horizontally outward from the eye wear frame 1 and attach directly to the interior portion of the full-face helmet visor 5 by utilizing the adherence device 4. The adherence device 4 as shown includes a releasing mechanism 10 and pin 11 that engages the suction cup 13 to adhere to an adjacent surface such as a glass surface for instance. The adherence device 4 is connected to the adjustable extension device 3 by the pin 11 that is inserted through the adherence device 4 that is connected to the releasing mechanism 10 and pin 11. The apparatus is shown with a spar portion 8 that is utilized to engage and support the adjustable extension device 3. The spar support 8 includes the aperture 6 that is designed to securely hold the adjustable extension device 3 while in use. The apparatus further includes nose support portions (9a, 9b). Once the adjustable device is attached to the spar support 8, it will be extended outward in a horizontal manner to be attached to the full-face helmet visor 5 via the adherence device 4. The drawing further shows levers (12a, 12b) that releases the extension device 3 from the eye wear frame 1.

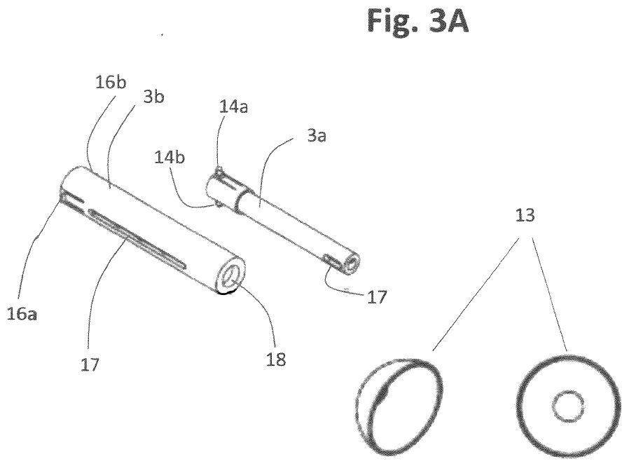

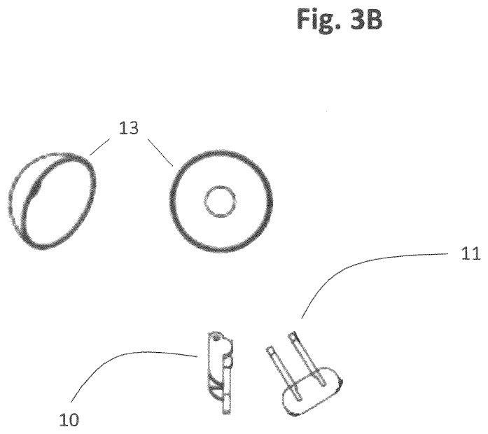

Turning now to FIG. 3A illustrates the telescopic rods (3a, 3b) and the suction cup 13 with associated features. The depictions show the perspective view of the male rod 3a separated from the female rod 3b. The male rod 3a further shows engagement rods (14a, 14b) extending from a distal end of the body of the male rod 3a. The engagement rods (14a, 14b) acts as securing mechanisms that engages with filisters (15a, 15b) in the female rod 3b once the telescopic rods (3a, 3b) are interlocked by inserting the male rod 3a into a cavity 18 of the female rod 3b. The illustration also shows a first attachment structure 16a and a second attachment structure 16b that protrudes from the body of the female rod for attaching to the eye glass frame 1 via the aperture 6. The illustration also shows a perspective view and front view of the suction cup 13. Once installed properly, the male rod 3a is coupled to the adherence device 4 (shown in FIG. 1) via the pin 11 (shown in FIG. 3B) through a slot 17 at the end of the male rod 3a.

Turning now to FIG. 3B illustrates the releasing mechanism 10 and pin 11. The releasing mechanism 10 is configured along the rear portion of the suction cup 4 to assist with releasing the suction cup from the interior surface of full-face helmet visor 5. The figure also depicts the pin 11 inserted through the releasing mechanism 10 to act as a cantilever when applying force to the releasing mechanism 10.

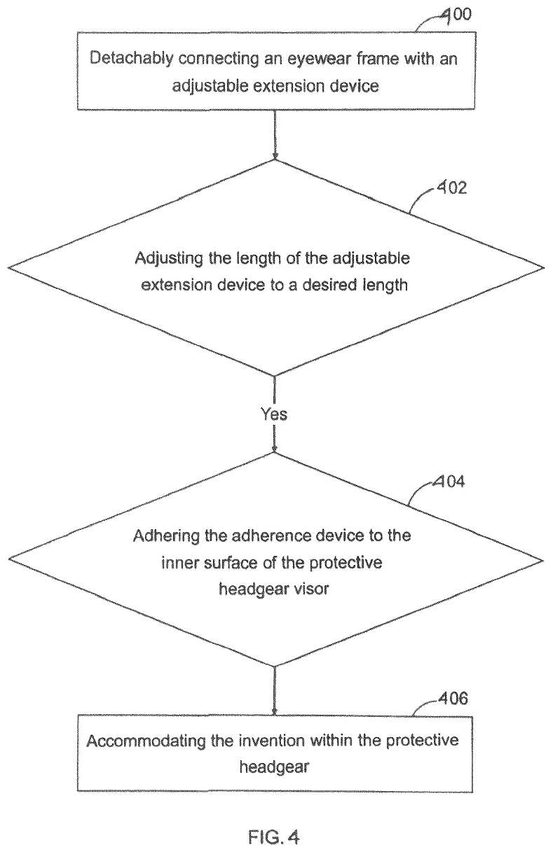

Turning now to FIG. 4 illustrates a flowchart to include the following steps:

Step 400 outlines the process of connecting a prescription lens frame to an adjustable extension device, which allows for the attachment and detachment of the frame. The prescription lens frame, referenced in sub-step 400-a, is designed to be coupled with the adjustable extension device, which is a telescopic rod as mentioned in sub-step 400-b. This telescopic rod can be lengthened or shortened to accommodate the user's needs.

The actions involved in step 400 include the mechanisms by which the frame is secured to or released from the telescopic rod. These mechanisms could include various types of connectors that ensure the frame can be reliably attached to the rod and removed when necessary. The purpose of this design is to provide users with the ability to use the prescription lens frame with a full-face helmet and to remove it with ease when it is not required, as indicated in sub-step 400-c.

The components involved in step 400 are the frame that holds the lenses and the telescopic rod that serves as the adjustable extension device. The process of connecting these two components is carried out by the user, who aligns and fastens the frame to the rod to ensure that the lenses are positioned correctly for use within the helmet. The process of detaching allows for the frame to be removed from the helmet, offering convenience and adaptability to the user.

In essence, step 400 and its sub-steps describe the interaction between the frame and the telescopic rod, detailing the process of attachment and detachment that allows for the flexible use of prescription lenses within a full-face helmet. This step is designed to integrate prescription lenses into protective headgear in a manner that is convenient for the user.

Step 402 involves the user adjusting the length of the adjustable extension device. This step is necessary to position the prescription lens frame appropriately for the user within the full-face helmet. The adjustable extension device is constructed from materials that can withstand the mechanical actions of extension and retraction.

Sub-step 402-b is the process where the user customizes the length of the adjustable extension device to match the size and shape of the protective headgear. This allows for personalization to meet different user preferences and ensures that the prescription lens frame is at an optimal distance from the user's eyes.

The actions in step 402 consist of the user manipulating the telescopic rod to either extend or retract it to the required length. This adjustment is based on the user's specific requirements for comfort and visual clarity. The user typically engages a locking mechanism on the telescopic rod, adjusts the segments to the desired length, and then secures the length by locking the mechanism back in place.

The materials used for the telescopic rod in sub-step 402-a are selected to ensure that the device can be adjusted repeatedly without losing its functional integrity. The adjustment process is guided by the need to align the prescription lenses with the user's eyes to provide clear vision while the helmet is worn. The design of the telescopic rod allows for this adjustment to be made with precision and maintains the adjusted length during use.

Step 404 involves the process of securing the suction cup to the inner surface of the protective headgear visor. The suction cup, as detailed in sub-step 404-a, includes several functional features to include a suction cup. This device operates by forming a vacuum seal against the visor surface when pressed onto it, which allows it to maintain its position due to the atmospheric pressure difference across its two sides.

Sub-step 404-b specifies that the adherence of the suction cup is to the interior surface of a full-face helmet visor. The surface properties of the visor are such that they allow the suction cup to form an adequate seal, ensuring that the attached prescription lens frame remains stationary during use.

In sub-step 404-c, the user is provided with the ability to adjust the position of the suction cup on the visor's inner surface. This adjustment is necessary to align the prescription lens frame appropriately in front of the user's eyes for clear vision. The adjustability feature accommodates variations in user facial features and helmet visor designs.

Overall, step 404 encompasses the application and positioning of the suction cup on the helmet visor, ensuring it is secure and correctly aligned. The suction cup must be capable of forming a reliable vacuum seal on the visor's surface and allow for positional adjustments to meet user requirements.

Step 406 involves placing the prescription lens frame, which is connected to the adjustable telescopic rod, inside the full-face helmet. This step requires precise positioning of the lens frame so that it aligns with the user's eyes, ensuring clear vision through the lenses while wearing the helmet. The adjustable telescopic rod allows for the length to be modified to accommodate different helmet sizes and shapes, ensuring a secure fit.

Sub-step 406-a specifies that the helmet is a full-face model, which typically includes a visor. The visor is relevant because the suction cup, which is part of the assembly, must adhere to its inner surface. This is where sub-step 406-b comes into play, as the visor provides the necessary surface for the suction cup to attach.

The placement of the lens frame assembly within the helmet is not a simple drop-in process; it requires adjustment to ensure that the lenses are correctly positioned. This is addressed in sub-step 406-c, where the lens frame's position can be modified to suit the user's needs. The suction cup's position can also be adjusted to optimize the placement of the lens frame, ensuring that the assembly remains stable during use and does not shift or obstruct the user's vision.

The design allows for the lens frame to be easily removed from the telescopic rod when not needed, as indicated in step 400-c. This feature adds to the practicality of the system, allowing users to quickly detach the lens frame from the helmet when it is not in use.

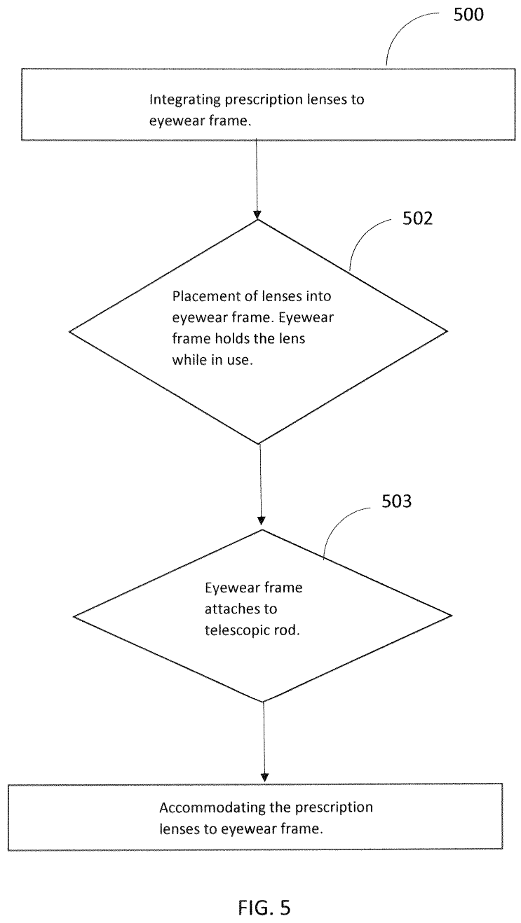

Turning now to FIG. 5 illustrates a flowchart to include the following steps: At step 500 the Eyewear Accommodation System is designed to integrate prescription lenses into full-face helmets, enhancing comfort and convenience for the wearer. Step 502 outlines how the eyewear frame holds the prescription lenses in place. Step 503 outlines how the eyewear frame connects to the Telescopic Rod, allowing for adjustable positioning. Step 504 involves securing the prescription lenses to the eyewear frame ensuring stability and usability.

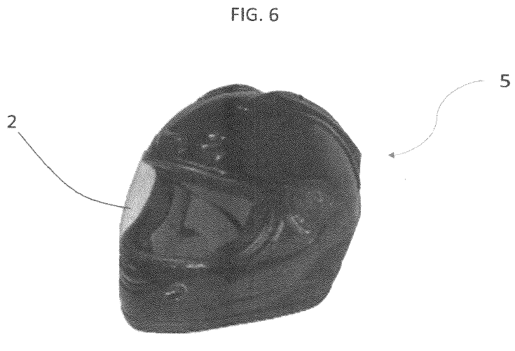

Turning now to FIG. 6 illustrates the full-face face helmet visor 5 that is typically used for recreational purposes. The adherence device 4 as described herein will be attached to the interior surface of the shield portion 2 of the full-face helmet visor 5 to allow the user to wear prescition galsses while using various recreational vehicles.

While the present invention has been described above in terms of specific embodiments for purposes of illustration, it is to be understood that the invention is not limited to these disclosed embodiments. Likewise, while “the invention” or “present invention” may have been referred to at the times in this disclosure those terms are not intended to limit the scope of this disclosure or to suggest in any way that there is a single version or embodiment. prescription lens frame designed for use with full-face helmets, the apparatus that fall within the scope of this disclosure may include a variety of optional features, which do not need to be present in every version or embodiment. Various modifications and changes can be made without departing from the spirit of the invention. In fact, modifications and other embodiments of the invention will also come to mind of those skilled in the art to which this invention pertains, and which are intended to be and are covered by both this disclosure and the appended claims. It is indeed intended that the scope should be determined by proper interpretation and construction of the appended claims and their legal equivalents, as understood by those skilled in the art relying upon the disclosure in this specification and the attached drawings.

The skilled person will be aware of a range of possible modifications of the various embodiments described above. Accordingly, the present invention is defined by the claims and their equivalents.

What is claimed is:

1. A system for accommodating eyewear within a protective headgear, comprising:
an eyewear frame having the ability to connect or disconnect with an adjustable extension device;
an adjustable extension device having the ability to connect with the eyewear frame and be adjusted in length;
an adherence device having the ability to stick to the inner surface of the protective headgear visor;
a protective headgear visor possessing an inner surface; and
a protective headgear having the capacity to house the invention.

2. The system of claim 1, wherein the eyewear frame is a prescription lens frame.

3. The system of claim 1, wherein the adjustable extension device is a telescopic rod.

4. The system of claim 1, the adherence device is a suction cup, wherein the suction cup has a releasing mechanism along the rear portion of the suction cup.

5. The system of claim 1, wherein the protective headgear is a full-face helmet.

6. The system of claim 1, wherein the protective headgear visor is a full-face helmet visor.

7. The system of claim 1, wherein the adjustable extension device is made from a durable material.

8. The system of claim 1, wherein the adherence device adheres to the interior surface of the full-face helmet visor.

9. A method for accommodating eyewear within a protective headgear, comprising the steps of:
detachably connecting an eyewear frame with an adjustable extension device;
adjusting the length of the adjustable extension device to a desired length;
attaching the adherence device to the inner surface of the protective headgear visor; and
accommodating the invention within the protective headgear.

10. The method of claim 9, wherein the eyewear frame is a prescription lens frame.

11. The method of claim 9, wherein the adjustable extension device is a telescopic rod.

12. The method of claim 9, wherein the adherence device includes a suction cup.

13. The method of claim 9, wherein the protective headgear is a full-face helmet.

14. The method of claim 9, wherein the protective headgear visor is a full-face helmet visor.

15. The method of claim 9, wherein the adjustable extension device is made from a durable material.

16. The method of claim 9, wherein the adherence device adheres to the interior surface of the full-face helmet visor.

17. The method of claim 9, further comprising the step of adjusting the position of the eyewear frame within the protective headgear.

18. The method of claim 9, further comprising the step of adjusting the position of the adherence device on the inner surface of the protective headgear visor.

19. The method of claim 9, further comprising the step of adjusting the length of the adjustable extension device to fit the size of the protective headgear.

20. The method of claim 9, further comprising the step of detaching the eyewear frame from the adjustable extension device when not in use.
